(19) United States
(12) Patent Application Publication
(10) Pub. No.: US 2010/0288269 A1
(43) Pub. Date: Nov. 18, 2010

(54) PROCESS FOR COMMERCIAL PRODUCTION OF CONCENTRATED SUGARY SYRUP WITH LOW ENERGY REQUIREMENT

(76) Inventor: Valerie Gay CHADBOURNE, North Bay (CA)

Correspondence Address: DEFILLO & ASSOCIATES, INC., P.O. Box 14104, Clearwater, FL, 33766, US

(21) Appl. No.: 12/778,803

(22) Filed: May 12, 2010

(30) Foreign Application Priority Data
May 13, 2009 (CA) 2,665,982

(51) Int. Cl. C13F 1/02

(52) U.S. Cl. 127/58

(57) ABSTRACT

The invention provides a process for the commercial production of sugar, particularly maple, syrup including the steps of exposure of collected raw sugar solutions and maple sap on-site to a predominantly or relatively naturally occurring cold surface, gradually cooling the sap to a temperature sufficient to commence freezing, continuing the cooling and freezing to form a solids body of sap ice and a component separate from the solids body containing first sugars, continuing the cooling and freezing until the first sugars containing component reaches a substantially thickened or solid consistency, and thirdly, separation of the first sugars containing component from the said solids body.

### FIELD OF THE INVENTION

The present invention relates to the process for production of sugar, particularly maple, syrup and the sugar and maple syrup products which result. In particular, the process provides a multiple step water extraction process driven by predominantly natural gradual freezing and thawing cycles applied to the collected raw sugar solutions or maple sap and separation of the resulting components before heat treatment.

### BACKGROUND OF THE INVENTION

It has long been the maple syrup industry common practise to gather sap from maple trees by a variety of methods. The raw sap is collected into one or more central reservoirs. Then the water content of the bulk sap is greatly reduced by boiling or evaporation, alone or in combination with reduced atmospheric pressure. In simpler manual systems the reservoir may be as simple as a bucket on a spigot at the individual tree while in more complex ones there are extended collection systems running from many trees to a single central location.

In the earliest days of mass production the sap collection was done by manual labour as individual buckets where removed from individual tree spigots and transported individually to a central location where reduction occurred over a wood burning fire. As demand and labour costs both rose the industry turned to these multi-point collection systems and improved thermal reduction with alternative fuels such as electricity and gas.

Further increases in demand and in costs resulted in improved equipment and processes for the reduction of the sap into the high sugars syrup demand in the marketplace. For the most part these improvements have been to further mechanize the process and provide bulk energy sources. While effective, these mechanizations bring with themselves a whole host of problems, solutions and, typically, much higher capital and operating costs while reducing the manual labour (skilled or unskilled) component.

There are several predetermined factors:

Maple Sap has approximately 3% pure sugar content,

Maple Syrup has approximately 66%-67% sugar,

The ratio of sap to syrup in typical production is 40-1. Thus, it takes 40 liters of maple sap to produce 1 liter of Maple syrup by means of conventional syrup production,

The freezing point of maple sap is lower than that of water, and

In ideal temperature conditions, maple sap runs effectively only when the ambient temperature is below −5 degree C. at night and no more than +5 degree C. during the day. A night time temperature of below about −5 degree C. is required for the sap to run in the trees themselves when the day warms up. A maximum effective daytime temperature of about +5 is required as the sap turns bitter as the trees begin to grow.

When hardwood fuel is used for thermal evaporation by boiling a standard cord (4′×4′×8′) will produce enough heat to make 68 litres (15 gallons) of maple syrup.

With oil fired evaporators it usually requires the heat from three to four litres (0.7 gallons-0.9 gallons) of fuel oil to make a single litre of maple syrup. Occasionally, a production efficiency of 1 litre of maple syrup for each litre of oil consumed has been achieved.

These processes are not known to be used for the production of other types of sugar syrup, sugar or sugar concentrate in which the plants themselves are typically mechanically collected in bulk form (harvested) and then shipped to a mechanized processing facility.

### THE PRIOR ART

The current mechanized processes of producing maple products by intense heat and evaporation methods, without more, hold back the growth of the maple industry and are not widely used for other sugars because it is currently energy intensive and time consuming thereby making these products expensive to produce. This in turn limits the prospects for the vast array of food and other products that could potentially be brought to manufacture and market as raw materials or as fully finished consumer or industrial products such as speciality industrial or consumer sugars, maple syrup and maple sugar. The reduction process is thermally generated with or without a reduced ambient pressure (vacuum) to assist.

It is reported that as much as 300 years ago European settlers found aboriginal peoples making a crude dark sugar from maple sap. They collected the sap from tree wounds in birch bark buckets. Next, water was driven off the sap by boiling the mixture until the sugar was made. Hot stones were thrown in to hollowed-out basswood logs or, possibly, earthenware containers, filled with maple sap to cause quick evaporation before the sap spoiled. It is suggested in a single report that an alternative was to allow the sap to freeze in its birch bark bucket and then dispose of the layer of ice which formed on the top of the sap overnight. This later technique, although reported in a single instance, is not known the by the present inventor to be operative at the relevant time and is not known to have been in use since any aboriginal origins, if at all. As far as this may be understood this was probably for preservative purposes as it appears that much of the sugars so laboriously and expensively collected would be thrown away and thermal evaporation would remain as the next processing step. Typically freezing was used to store the sap until sufficient quantities are collected for thermal processing as the sap will spoil if not treated quickly.

European settlers improved on collection methods at the tree and used wooden buckets to collect the sap. The sap was initially boiled in iron kettles and later in flat bottomed pans. By the early 1900's a flue type evaporator became common. Deep corrugations in the bottom of the pan provided a large area of contact between the fire and the pan thus boiling the sap more quickly. All of these assume the ready availability of a high quantity of thermal energy such as would be available from a wood or gas fire.

It is not widely understood that naturally occurring sugar syrups such as maple syrup are biologically active to very active at temperatures as low as 4.5° C. This biological activity can manifest itself at any stage of harvest, collection, processing, storage and consumption. The prior art and industry standards suggests that the most effective way of combating this biological degradation is to maintain low temperatures for storage and transport and to subject the syrup to high (boiling) temperatures for the purpose of sterilization as well as for reduction.

More efficient systems to process sap into maple syrup have been developed since about 1950 and in the 1970's reverse osmosis processing (RO) was introduced. By using RO technology the sugar concentration in raw sap is increased from about 2-3 percent to about 8 percent or more before the sap is boiled to produce syrup. The primary benefit of this RO process is to greatly reduce the energy input required for effective production. Reverse osmosis as far as is known by the present inventor can reduce the water content from the sap by as much as 75%. In place of the energy costs and the existing on-site equipment RO processing requires a whole new type and quantity of specialized and expensive equipment with sensitive membranes and the like. In addition to the electrical power required for operation, and the greatly increased capitalization, skilled and highly trained work persons are needed to satisfactorily operate this equipment on seasonal basis. As a result, RO technology has not taken a significant hold, especially among smaller operatives.

Unfortunately, with all known operating methods much of the lighter fractions of the natural maple sap are simply allowed to evaporate to atmosphere as they are driven off by heat from thermal evaporation at ambient atmospheric pressure or below.

It is known that sap in collection systems may freeze overnight in suitable conditions and require thawing out as the day warms up for transport and evaporation as discussed in Canadian Patent 1,323,986 to Chabot. This is primarily used for preservation of the sap while collection continues until suitable processing volumes are reached.

In unrelated arts it is known that freeze drying processes are effective for the mass production of concentrated fruit and vegetable juices but these are technologically and economically complex systems involving inert gases and the removal of substantially pure ice crystals from the mix. Portions are then recombined with the original liquid to return flavour and substance to the result such as are discussed in U.S. Pat. No. 4,463,025 issued Jul. 31, 1984 to Strobel, U.S. Pat. No. 6,254,913 issued Mar. 7, 2001 to Wadsworth.

While freeze distillation and its companion, freeze concentration, are known techniques but their application to taste sensitive food products has been problematic. An example is fruit juice and ice beer as described in US RE36,897. Another is described in Canadian patent 673,672 wherein freeze concentration is used to improve upon the traditional beer making process. As described, the process requires the formation of semi-frozen slurry of liquid and ice crystals from which the ice crystals are removed in an inert atmosphere.

A further is described in Canadian patent 601,487 wherein freeze concentration is described in respect of a variety of liquids such as juice, beer, wine, resins, coffee, milk and pharmaceuticals wherein a low differential of temperature is provided between the freezing solution and the coolant. The process involves stepwise progressive freezing with the result being fine solvent (water) crystals and removal of those crystals at low differentials of temperature (5-7 degrees F.). Ice crystals are removed stepwise. In most prior cases referred to the quantity of heat transfer and, thus, formation of ice, is large and presents an entirely different technical problem. In both cases the common element is slurry from which ice crystals are removed.

Yet again in Canadian patent 710,662 issued 1965 the process for freeze concentration is described as the formation of semi-frozen slurry of frozen component and solvent. There it is the extraction of the solvent from the slurry which presents the main technical issue as too much solvent remains.

In all of the above examples the technique has been to form semi-solid slurry of unfrozen solvent and ice crystals by rapid reduction in the temperature of the solution either with a high or low temperature differential freezer.

As far as the present inventor is away the technical focus has been upon the rapidity and cost of production of suitable ice crystal slurry without product degradation. Reported efforts have included high temperature differential rapid freezing and as a low cost alternative a low temperature differential but high thermal transfer apparatus.

In most known cases in the prior art these efforts have not been suitable in result despite the high capital investment and high energy costs encountered. This is particularly so where a multi-step process is described.

While it is the quality of the end product which causes most efforts to fail it is also noted in the prior art that solids handling is a problem as solids can't be pumped or compressed. Mechanical manipulation of the solid wears away at machinery as freezing will occur wherever conditions are favourable, particularly along the tank and machinery walls necessary for mechanized production. It is also noted that solids do not diffuse well. Freezing produces temperature gradients and it is known that impure solid products result. This is noted at www.halfbakery.com/idea/freeze_20Distillation.

It is noted by one author in 1950 that freeze concentration generally does not result in a product which has the characteristic colour, flavour, or aroma of even the thermally generated typical maple syrup. The author notes that the true maple flavour and amber colour are developed by boiling.

None of such processes are known to be suitable for usage in a sugar bush as, typically, the sugaring off process occurs within a short distance from the point of collection.

### SUMMARY OF THE INVENTION

An objective of the sugar concentration process invention is to effectively separate water from the sugar in a sugar solution such as maple sap and provide for the practical application of alternative energy use in the manufacturing of sugar or maple syrup products.

Another objective of the invention is to provide an energy efficient and effective way of controllably and successfully separate removing water from raw, as collected on site, sugar solutions and maple sap.

A further objective is to provide a water elimination process which promotes the environmentally clean harvesting and production of plant sugary solutions such as tree sap and the lessening of the current industry's costly and energy intense carbon footprint by as much as an estimated 90%.

A still further objective of the process of the invention is to provide for on-site extraction in a manner simply and economically incorporated into existing production infrastructure with a broad allowance for the manufacturers needs without further capitalization of expensive and technically complicated equipment or the requirement for further and other labour skills and replaceable parts. A calculation of the manpower and time requirements for a simple boiling procedures resulting in major reduction in volume, leaving out capitalization and profit requirements, demonstrates the substantial cost component of production compelling automated mechanical bulk procedures.

A still further objective is to provide an extraction process which uses the natural climatic freeze and thaw process of production days on in the early spring to concentrate sugary solutions such as maple sap into a syrup.

A still further objective is to provide a process whereby full use of all of the original sap characteristics and flavours harvested or collected from trees is maintained without significant thermal degradation unlike the conventional maple sugar harvesting method that evaporates lighter fractions. The traditional method of burn off evaporates some sugars and lighter materials away, along with the harvested water or tree water during the heating process.

Another objective is to provide a process whereby the quality of sugars obtained may be maintained in controlled portions allowing the sap to be easily manipulated to suit the regional and global market demand.

A still further objective is to avoid the traditional method of burn off, with or without pressure reduction, as these evaporate some sugar away along with the tree water during the heat processes.

Another object is to maintain the temperature of the sap throughout the processing steps as low as possible, and preferably as low as about 4.5° C. so as to avoid substantial biological activity whether pre-filtered or not.

It is yet another objective of the invention is to manage the removal of water from the collected raw sap in a shorter processing time thereby making alternative energy sources such as passive or photovoltaic solar on site energy a viable option in completing the solution or maple syrup process due to the substantial reduction in total energy requirements on site and use of all available on site energy resources.

It is a still further objective to provide an improved method of sugar solution or maple sap reduction which may be operated effectively during the extremely short production season in a wide variety of small to medium size maple forest or harvest locations and thereby expand total production while remaining within the existing means of the small to medium sized operator in a market for which it is believed that demand plus potential demand far exceeds available supply.

It is an even further object of the invention to provide a naturally generated maple syrup product with a beautiful amber colour with higher Brix numbers having better colours and taste which can be pre-filtered so as to remain bacteria free with a high clarity after weeks without refrigeration.

### DESCRIPTION OF THE PRESENT INVENTION

The process of the invention can reduce water content on site in sugar solution and maple sap to the required sugars measurement in a clean and naturally occurring way which can be readily enhanced, if required. Water reduction can be as much as 20% more efficient than the reverse osmosis (RO) process and provide a 75% water reduction by using the natural climate condition in the freeze and thaw process of daily cooling and warming.

Thus, undesired water is reduced to levels required by further processing steps such as caramelizing and sterilization in order to achieve the goal of a finished sugar or maple syrup with ⅓ water and ⅔ sugars.

The invention provides a process for the production of sugar or maple syrup and the syrup product produced comprising the steps of, firstly, collecting raw harvested sugar solution or maple sap (herein ‘sap’) in quantity, and, secondly, exposure of the said collected raw sap to a cold surface, cooling said sap on said cold surface to a temperature sufficient to commence freezing of the sap liquid on that surface, continuing said cooling and freezing gradually to form a solids body of sap ice on that surface and to separate a first sugars containing liquid component of the sap from the forming solids body, continuing said cooling and freezing until the said first sugars containing component reaches a substantially thickened or solid consistency, and, thirdly, separation of said first sugars containing component from the said solids body. By the process the raw sap is selectively cooled and frozen into the said collected sap quantity to cause a first sugars containing component maple gel to form in the body of the collected raw sap and on the solids body. The first sugars containing component is an unfrozen and thick honey-like liquid syrup sugar gel with a sugar content of about ⅔ of the 3% originally available in the raw sap. The cold surface is provided and maintained by the naturally occurring temperature drop as warm spring days turn into freezing cold nights at the point of collection or collection.

In another aspect the invention provides a process wherein the cooling and freezing on the cold surface is accompanied by maintenance of the balance of the sap at a temperature whereat there is little or no tendency for the sap to form a slurry of ice crystals.

The invention also provides a further process and sugar or maple syrup product wherein separation of the gel is carried out either by mechanical means such as scraping or by exposure of the solids body to a heat source opposite said surface causes the sap ice to commence melting, or a combination of both, and collecting said melt liquid having the highest concentration of remaining sugars running off first, preferably in a downward direction. Preferably the separation heat source is also naturally occurring as by the warming of a spring day, before, during or after the day warms to the point where sap begins to flow again in the trees.

By the process the melt liquid is then re-combined with the sugar gel and subjected to thermal cooking or curing into a traditional amber coloured flavourful sugar or maple syrup. Due to the now substantially reduced volumes thermal cooking or curing, or just a degree or warming, may be supplied by naturally occurring reduced carbon emissions sources such as on site solar energy.

In a further aspect the invention provides a separation process which may be combined with a pre-filtering of the sap so that the result will be bacteria free and remain clear and suitable for consumption even after weeks of refrigeration.

### PREFERRED EMBODIMENTS

With the preferred embodiment of the invention raw sugar solution or maple sap (herein ‘sap’) is collected in suitable quantities by conventional means such as tube collection systems or bucket runs.

According to step 1 of the preferred embodiment process of the invention the collected raw sap liquid (approximately 3% notable sugars) is exposed on-site to a cold surface and selectively cooled on that cold surface to a temperature sufficient to commence freezing of the sap liquid into a solids body of sap ice adjacent said cold surface. The cold surface is preferably an interior surface of a simple bulk container itself exposed to low (below freezing) ambient temperatures or, alternatively, an artificially cooled or refrigerated surface either stationary or in relative motion in respect of the sap.

Most preferably the cold surface is provided by the ambient air conditions on site as the warmth of the day required for the sap to flow turns into the cold of an early springtime evening and night.

Further preferably the sap liquid is maintained at a temperature whereat no significant formation of ice slurry within the sap liquid occurs during the process.

The cooling of step 1 is continued as a 1^{st} liquid component of the freezing process is separated, preferably upwardly, horizontally or diagonally, alone or in combination, from the partially formed and continuously forming solids body of, principally, frozen ice crystals and ice referred to collectively as ‘sap ice’.

The cooling of step 1 is further continued until the remaining unfrozen constituent reaches a suitable consistency. This consistency may be selected to be a thickened liquid, or a semi-solid, but is preferably that of a unfrozen and thick honey-like liquid syrup called ‘maple gel’ with a sugar content of about ⅔ of the 3% originally available in the sap and as much as approximately 46% of the maple gel volume.

Preferably the cooling exposure of step 1 is carried out so as to provide a gradually decreasing sap temperature adjacent the said surface.

Further preferably the cooling of step 1 is carried out from the outside surface of the sap liquid so that the body of the collected sap liquid freezes inwards and upwards and causes the sugar gel to form and remain substantially on the surface of the said solids body.

Further preferably the collected sap may be pre-filtered to reduce components of the naturally occurring product in the final resultant.

According to step 2 of the preferred embodiment process of the invention, the gel is then removed from the sap ice, preferably mechanically as by scraping or vacuum suction, and set aside. Preferably the separation step of the process occurs in the small hours of the springtime morning was daylight returns to the site and warmth returns to repeat the daily cycle.

According to step 3 of the preferred embodiment process of the invention, the sap ice, now substantially a frozen solid with reduced sugars content, is exposed to a gentle heat source principally opposite to said cold surface to provide an increasing temperature, preferably slowly increasing uniformly over an area of the solids body, so as to cause the sap ice to commence a slow melting preferably confined opposite said cold surface. Higher sugars content sap ice more preferably directly exposed to the increasing heat will melt fastest and provide a melt liquid having the highest concentration of remaining sugars available running off or available for vacuum suction up first. Most preferably, the heat source is again the ambient air as it may be augmented by sunlight as the day progressively warms before, during and after the sap begins to run again. Alternatively, low carbon emission natural sources of energy such as on site solar energy may be used in steps 2 and 3.

Increasing the availability of heat or a higher temperature from the heat source will increasingly speed up the melting process and, correspondingly, melt-water dilution interferes with the sugar concentration in the result.

Preferably the temperature of the invention at all steps is limited to a low temperature consistent with limited or no biological activity within the sap, the gel or the melt product such as below about 10° C. or, preferably, below about 4.5° C.

Most preferably at no time in the process of the invention is the sap, the gel or the solids body rendered fully or partially into an ice slurry whether by freezing at 1^{st} instance or by grinding, hammering or centrifuging.

Preferably step 3 is preferably carried out with the sap ice in an inverted position to that the melt liquid, forming sugar syrup, may be predictably and simply separated and set aside. Separation of the first ⅔ of this melted syrup will provide a sugar content of about 15% (that is approximately 81% of the available sugars) and the balance with only trace sugar.

Further preferably the heat source exposure of step 3 is limited to the now-inverted surface of the sap ice.

According to step 4 of the preferred embodiment process of the invention, the melting sap ice is predictably captured below the frozen solid of step 3.

In a further preferred embodiment of the process, the separation in step 3 is carried out in multiple sequential small increments, each providing decreasing sugars content as the melting is continued.

In a still further embodiment of the preferred embodiment process of the invention the sweeter of the separated amounts of melted syrup are processed again according to steps 1 and following of the preferred embodiments of the invention. This repetition with the sugars syrup results in further capture of approximately ⅓ of the remaining sugar which may be added to the already captured ⅔ of the originally available sugar. These may occur over a period of several days in ambient on-site conditions.

Although the process may be continued through further repetitions it has been found that the balance of the melt from step 3 contains only traces of useable sugar.

Most preferably with the preferred embodiment process of the invention almost all of the total sugar content of the raw maple sap is extracted after 2 freeze and thaw cycles.

In a further embodiment of the invention at step #1 the sap is exposed to an enclosing or partially enclosing cold surface for a sufficiently long period that the bulk of the sap becomes a frozen solids body surrounded by and/or including the gel. In this embodiment an additional step in the process may be included whereby the exterior gel is removed and the remaining solids body is mechanically broken up into manageable pieces but not ground or turned to a slurry state. The remaining portions of the solids body are laid out on a second cold surface prior to the heat exposure. In the case of a vertical cylindrical cold surface whereby the solids body is formed in a tubular fashion with a decreasing internal diameter preferably the gel will remain on the upper surface but a portion main remaining pooled at the bottom and/or centrally located, or both, and another portion may locate at other locations around the solids body. In such cases, the additional step of mechanical break up is required to retrieve gel prior to the heating step of the invention.

Once sugar extraction has been completed the extracted liquids (which remained clear throughout) are heated temporarily, such as by on site low carbon footprint energy sources such as solar, to cure the maple syrup to the completed amber coloured nectar of the invention.

Testing shows that a typical maple sap with 3° Brix sugar content processed according to invention at −1 through +2° C. will have the highest resulting sugar concentration. Including the 1^{st} ⅓ of the melted solids body will readily capture 81% of the available sugar. A sugar concentration of 73 percent (73° Brix) was readily obtained in step 2 with the sap frozen and the gel dripped off the resulting solids body with both steps at −18° C.

While particular embodiments of the invention have been described, it will be understood, of course, that the invention is not limited thereto, and that many obvious modifications and variations can be made, and that such modifications and variations are intended to fall within the scope of the appended claims.

1. A process for the production of sugar syrup comprising the steps of:
a) collecting a raw sugar solution or sap liquid and exposing said collected raw sugar solution or sap liquid sap to a cold surface,
b) cooling said raw sugar solution or sap liquid on said surface to a temperature sufficient to slowly commence and continue freezing through the raw sugar solution or sap liquid,
c) continuing said cooling and freezing gradually to form a solid body of sap ice and to separate a first sugars containing liquid component of the sap from the forming solids body,
d) continuing said cooling and freezing until the said first sugars containing component reaches a substantially thickened or solid consistency, and
e) separation of said first sugars containing component from the said solids body.

2. The process as claimed in claim 1 further wherein said raw sugar solution or sap liquid is selectively cooled and frozen.

3. The process as claimed in claim 2 wherein said first sugars containing component is an unfrozen and thick liquid honey-like syrup gel with a sugar content of about ⅔ of the 3% originally available in the raw sap.

4. The process as claimed in claim 3 wherein said selective cooling and freezing of the raw sap is principally upwardly and horizontally into the said collected sap quantity.

5. The process as claimed in claim 4 wherein the first sugars containing component gel forms on the surface of the body of collected raw sap.

6. The process as claimed in claim 3 further comprising exposing said solids body to a low heat source opposite to said cold surface so as to cause the sap ice to commence melting and collecting said melt liquid.

7. The process as claimed in claim 6 wherein said exposing is adapted to provide a melt liquid having the highest concentration of remaining sugars running off first.

8. The process as claimed in claim 7 wherein said exposing is directed to the last-formed component of the said sap ice.

9. The process as claimed in claim 8 further comprising the step of repeating the steps of the process with said melt liquid.

10. The process as claimed in the claim 8 further comprising combining said maple gel and the final melt liquid into a combined syrup and repeating the process with the combined syrup.

11. The process as claimed in claim 10 further comprising curing or cooking said combined syrup to form maple syrup.

12. The process as claimed in claim 4 where said collection and exposure occurs on site in proximity to the source of the raw sap.

13. The process as claimed in claim 12 wherein one or more of said steps of cooling, freezing and melting occur without the use of significant quantities of stored energy provided from an off site source.

14. The process as claimed in claim 13 wherein said energy is a hydrocarbon based fuel.

15. A syrup product produced by the process comprising the steps of the process of claim 8.

16. A process as claimed in claim 1 wherein the sugar solution or sap is maple sap.

17. A process as claimed in claim 1 wherein the said freezing occurs without the formation of any significantly quantity of ice slurry within the first sugars containing component.

18. A process as claimed in claim 1 wherein each step is carried out using principally daily natural freeze and thaw cycles.

19. A process as claimed in claim 18 wherein heating steps are augmented in whole or in part by solar energy.
